(19) United States
(12) Patent Application Publication
(10) Pub. No.: US 2007/0125181 A1
(43) Pub. Date: Jun. 7, 2007

(54) Polymer Nanosensor Device

(75) Inventors: Eran Ofek, Modi'in (IL); Noel Axelrod, Jerusalem (IL); Amir Lichtenstein, Tel Aviv (IL); Vered Pardo-Yissar, Neve-Monoson (IL)

Correspondence Address: EDWARD S. SHERMAN, ESQ., 3554 ROUND BARN BLVD., SUITE 303, SANTA ROSA, CA, 95403, US

(73) Assignee: Physical Logic AG, Zug (CH)

(21) Appl. No.: 11/561,405

(22) Filed: Nov. 19, 2006

Related U.S. Application Data
(60) Provisional application No. 60/738,927, filed on Nov. 21, 2005.
(60) Provisional application No. 60/738,793, filed on Nov. 21, 2005.
(60) Provisional application No. 60/738,778, filed on Nov. 21, 2005.

(51) Int. Cl. G01B 7/16

(52) U.S. Cl. 73/778

(57) ABSTRACT

A plurality of particles are densely packed as an array on a flexible substrate. As at least a portion of the substrate responds mechanically to an external stimulus, the coated substrate is useful as a sensor device to the extent that the mechanical response produces a separation between particles resulting in a measurable change in the physical properties of the array. Preferably the particles are conductive, spherical and of nano-scale for greater sensitivity. When the array comprises closely packed conductive nano-particles deformation of the substrate disturbs the electrical continuity between the particles resulting in a significant increase in resistivity. The various optical properties of the device may exhibit measurable changes depending on the size and composition of the nano-particles, as well as the means for attaching them to the substrate.

### CROSS REFERENCE TO RELATED APPLICATIONS

The present application claims priority to the U.S. provisional application having Ser. No. 60/738,927 entitled “Nanoparticle Vibration and Acceleration Sensors”, filed on Nov. 21, 2006 which is incorporated herein by reference. The present application also claims priority to the U.S. provisional application having Ser. No. 60/738,793 entitled “Nanoscale Sensor”, filed on Nov. 21, 2006 which is incorporated herein by reference. The present application further claims priority to the U.S. provisional application having Ser. No. 60/738,778 entitled “Polymer Nanosensor Device”, filed on Nov. 21, 2006 which is incorporated herein by reference.

### BACKGROUND OF INVENTION

The present invention relates to a composition of matter useful structures and configurations for forming sensors having an ultra-high sensitivity to acceleration, deformation, vibration and the like physical disturbances.

Prior methods of sensing small mechanical movements, vibration or acceleration generally deploy micro-electrical mechanical systems (MEMS) type devices. Such devices can be fabricated in part on silicon wafers extending technology developed for semiconductor microelectronic processing. The current generation of such sensors needs power, which increases their size and limits the life span. There is a continuing effort to increase the sensitivity of such devices, reduce their size and power consumption to expand their deployment to a wide range of engineering, industrial, aerospace and medical applications. It is particularly desirable to achieve a level of sensor miniaturization to be able to implant such sensor devices into structures or operating equipment without disturbing operation or taking space.

Ideally, it would be desirable to have sensors that can detect motion on a molecular scale level, without interfering with molecular scale processes. For example, many biological processes occur on a cellular level and are inherently nanoscale. The failure of structures and engineering materials initiates as a nanoscale process.

### SUMMARY OF INVENTION

In order to detect the smallest movements or vibrations it would be desirable to have a sensor having a functional element that is nano sized, yet wherein the changes in the sensor properties would be readily measurable on a macroscopic level for high reliability and facile integration with electronics and instruments. For example, it would be desirable that the state of the sensor device could be read continuously by very low power electrical or optical measurements. Such a nano sized sensor could conceivably be integrated with other items of manufacture or used in the human body yet without interfering with function. Indeed a nanoscale sensor element would have to be able to respond to affine deformation on a nanoscale to enable nanoscale devices.

Ideally, nanoscale sensor elements that can be deposited by thin film deposition methods generally compatible with semiconductor type processing steps used to manufacture MEMS and nanoscale device.

The above an other advantages and objects have been accomplished by the invention of a nano-sensor comprising a substrate, a polymeric spacer layer disposed on said substrate, an array of particles bonded to the surface of said polymeric spacer, whereby deformation of at least one of said substrates and said polymeric spacer layer results in a perturbation to the distribution of the nano-particles in said array to produce a measurable change in the aggregate physical property of said array.

In still other and preferred embodiments of the invention, the particles are electrically conductive nanospheres. The use of conductive nanospheres allows a relatively small perturbation to the array to be measured by electrical continuity across the device. In other embodiments, the particles are nanocrystals or quantum dots whose optical properties depend on the state of coalescence or aggregation.

The various embodiments of the invention described herein under have a low mass or inertia and provide a high sensitivity to force, vibration or other distortions of the substrate or polymer spacer. Small physical size and methods of making the sensor enable packaging and/or combination with integrated circuits for signal processing, analysis and/or display

The above and other objects, effects, features, and advantages of the present invention will become more apparent from the following description of the embodiments thereof taken in conjunction with the accompanying drawings.

### BRIEF DESCRIPTION OF DRAWINGS

FIG. 1 is a cross-section view schematically illustrating the nano and molecular structure of the sensor (FIG. 1a) and the operative principles thereof (in FIG. 1b)

FIG. 2 is a cross-section view schematically illustrating a method of forming the nano and molecular structure of the sensor of FIG. 1

FIG. 3 is a cross-section view schematically illustrating the nano and molecular structure of alternative sensor embodiment.

FIG. 4 is a cross-section view schematically illustrating the device of FIG. 1 deployed with additional components as a sensor.

FIG. 5 is a cross-section view schematically illustrating the device of FIG. 1 deployed with additional components as a sensor.

FIG. 6A is a cross-section view of an alternative nano and molecular structure for use as a sensor. FIG. 6B illustrates the operative principle of FIG. 6A

FIG. 7 is a theoretical (calculated from a FEM model) plot of resistance of a nanoparticle array as a function of distance between particles for nanoparticle materials of different work functions.

FIG. 8 is a theoretical (calculated from a FEM model) plot of resistance versus nanoparticle displacement.

### DETAILED DESCRIPTION

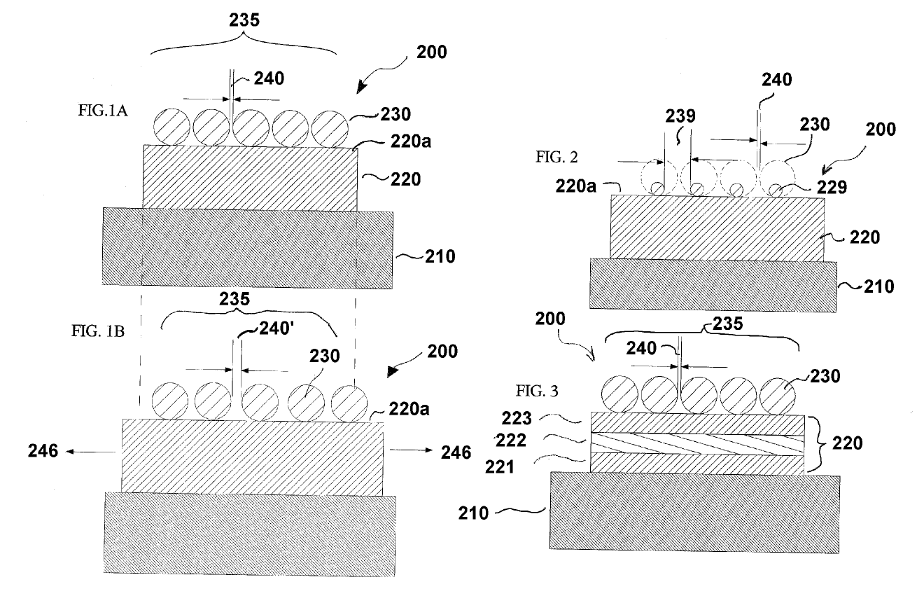

Referring to FIGS. 1 through 8, wherein like reference numerals refer to like components in the various views, there is illustrated therein a new and improved polymer nanosensor device, generally denominated 200 herein.

In accordance with the present invention, as illustrated in FIG. 1A a nanoscale device 200 is constructed on a substrate 210. A relatively thin polymeric layer 220 is disposed on substrate 200. Substantially equiaxed particles 230 are attached on the upper or outer surface 220a of polymer layer 220. The particles 230 are deposited on polymer layer 220 to form an array 235 wherein the thickness of polymer layer 220 is of comparable size scale to the particles 230. In the case of conductive particles, there will be electrical continuity across array 235. A gap 240 may exist between particles 230 in array 235. It is believed that a gap of several nanometers between particles will still lead to electrical continuity because electrons can quantum tunnel across such a narrow gap. The gap 240 is preferably between about 0 to 2 nm, and more preferably 0.2-0.7 nm. As the particle spacing increases the probability of quantum tunneling decreases such that electrical resistance increases in a measurable fashion. Because the tunneling current is highly sensitive to distance variation when the array is closely packed, such a device is highly sensitive, and can undergo changes in resistance of four or more orders of magnitude when the particle separation increases by a mere fraction of the particle diameter. The structure in FIG. 1 is useful in sensor devices because the change in particle spacing can be measured either electrically, through continuity measurements across the array, or optically as will be further described with respect to other specific embodiments.

FIG. 1B illustrates the operative principle of the device when the polymeric layer 220 undergoes a disturbance, such as an affine deformation. When the polymeric layer 220 or substrate 210 is slightly deformed, either by strain in the direction of arrows 246, or bent in the plane perpendicular to the drawing, the particles 230 become spaced further apart, having a larger inter particle gap 240′. The increase in particle separation thus results in increase in electrical resistance, i.e. a decrease in electrical conductivity. As a very small increase in the gap 240 between particles 230 will result in a large increase in resistance, the ideal ordered array 235 provides a highly sensitive means to detect deformation of the polymeric layer 220 or the substrate 210.

For nanoscale devices and sensors it is highly desirable that the particles are spherical and of a nano size scale. Accordingly, it is further desirable to maintain the initial spacing of the particles in FIG. 1A in a planar array by coating or planarizing the preferably planar substrate 210 with the polymer layer 220.

It should also be apparent, that the structure illustrated in FIG. 1. can also measure the change in temperature of the environment as a result of the thermal expansion effect of the substrate. Where the temperature rises, the substrate will expand and therefore the distance between the columns 220 will changes and therefore the distance between particles 230 will also change causing a measurable change in the electrical conductivity of the array 235. It should also be appreciated that when the temperature will decrease, the substrate will contract back and the effect will be reversed.

It should also be appreciated that in case that substrate 210 is comprised of two different materials that have different thermal expansion coefficients, the sensitivity of device 200 to temperature changes will be increased as a result of the fact that the changes in the expansion of both substrate will cause a larger deformation and therefore will cause a greater change in the electrical resistance of device 200.

The preferred embodiments deploy particles that are preferably of a nano size scale, spherical and mono-dispersed in size. More specifically the size of such nano-scale particle is preferably 1 to 100 nanometers, and more preferably 5 to 50 nanometers. Further, the particles are preferably conductive, and may include Au, Ag, Pt, Pd, boron or phosphorus doped Ni, ITO, SnO2, and the like, as well as mixtures thereof. It is more preferable that the particles are of noble metals not subject to oxidation that would increase the inter-particle resistivity, i.e. Au, Pt or Pd. In light of the foregoing, one of ordinary skill in the art will appreciates that alternatives nano scale particles include non-conductive particles having a metallic or otherwise stable conductive coating, such as phosphorus or boron-doped nickel that might be deposited by electro less deposition from solution.

Gold particles suitable for use as nanoparticles 230 can be made by first dissolving 10 mg HAuCl₄ in 98 ml deionized water. While this solution is vigorously refluxing, with stirring or other agitation, 2 ml of a solution of 100 mg of trisodium citrate solution in 10 ml deionized water is rapidly injected to disperse uniformly. Continuing the reflux and stirring for about a 1 hour will produce a clear liquid with a red color. Thereafter, heating is stopped while stirring continues until the red liquid reaches room temperature. Alternatively, gold nanoparticles of various sizes may be purchased from commercial sources, such as Nanoprobes, Incorporated: 95 Horse Block Road, Yaphank, N.Y. 11980-9710, USA. Gold nanoparticles sold under the name “NANOGOLD”™ by Nanprobes are available pre-coupled with functional groups for immobilization and bonding to surfaces, and in particular to biomolecules for use as markers and contrast enhancing agents. Accordingly, it will be appreciated by one of ordinary skill in the art that the polymer composition selected for layer 220 preferably has either on the backbone, branches or side chains reactive functional groups for bonding with the functional groups pre-coupled to the nanoparticles.

The particle arrays of the instant invention can be distinguished from prior art sensors or devices that measure changes of resistivity of dispersed conductive particles. Such dispersions are not controlled, that is they are random and hence depend on the density of particles reaching a percolation threshold to function. However, when the percolation threshold is reached there will also be a random separation distance between particles throughout the material.

However, the scale, size and structure of the arrays of the instant invention offers unique advantages over this prior art. First, it should be appreciated that because the spacing between particles can be controlled by manipulation of the polymer surface 220a, the device sensitivity can be extremely high (that is detect nanoscale deformation) with a very high dynamic range.

The electrical properties of the intended nanoparticle array can be modeled as a square lattice of spherical metallic (such as gold for example, but other materials are also possible) nanoparticles of radius r where the mean distance between the particles is d. We assume further that the position of each nanoparticle is random is described by the Gaussian distribution with standard deviation σ the optimum. The first row and the last row of nanoparticles are placed on electrodes that are connected to the DC voltage source. The tunneling probability p between two neighboring particles is given by the expression:
ρ=A exp(−2βd) (1)

where d is the distance between the particles, β is the tunneling coefficient and A is normalization coefficient. The parameter β depends on the work function of the metal W_{f} and on the energy of the electron E as

$$β = \sqrt{\frac{2 {m}_{e} ( {W}_{f} - E )}{{ℏ}^{2}}} \qquad ( 2 )$$

where mₑ is the electron mass and E is given by the expression
E=Eₙ+eE·d (3)

where the first term in the Eq. (3) represents the energy on the n^{th} level of the electron in the particle and the second term is contribution to the energy due to electric potential between the electrodes. E In Eq. (3) is the electrical field between the nanoparticles. The probability to find an electron on the level Eₙ is given by Fermi distribution.

For typical values of the work functions of metals in the range 4 to 5 eV, the value of β is about 1 Å⁻¹. The total resistance between the electrodes can be calculated when we consider the system to be a network of resistors. Each resistance in this network represents the tunneling resistance between two nanoparticles. Since the tunneling resistance is inversely proportional to the tunneling rate, it could be written from Eq. 1 as following
R_{p,q}=R₀ exp(2β_{p,q}d_{p,q}) (4)

where the indexes p, q refer to the two adjacent particles and R₀ is the contact resistance between two nanoparticles.

The total resistance R of the entire circuit will depend on a number of parameters, such as the mean distance between the nanoparticles d, the standard deviation in position of the nanoparticles σ, which is a parameter of the lattice disorder, on the size of the lattice M×N, on the working function W_{f} of the nanoparticle material, on the temperature T and on the voltage V between the electrodes, etc. If we consider a system of nanoparticles as a piezoresistive device, that is the resistance of the device changes due to applied stress, then we should take into account that there is an upper limit of resistance of the sensing element. This limit can be determined by a number of physical reasons such as the minimum detectable current or thermal noise on the resistance.

The thermal noise power for a detection system of a bandwidth B is P_{n,th}=4 k_{B}TB where k_{B} is the Boltzman constant, T is temperature. The thermal noise can be treated as the voltage noise through the relation P_{n,th}= V̅_̅{̅n̅,̅t̅h̅}̅²̅/R. Where V_{n,th} is the thermal voltage.

For example, the resistance R=10¹¹ Ω gives the thermal voltage noise of 40 μV/√Hz or about 1.3 mV in a bandwidth of 1 KHz. In addition, for R=10¹¹ Ω the current between the electrodes is only 1 nA for a 10 V bias. That current is comparable with the leakage currents in semi-conductive materials. If we restrict ourselves by the maximum resistance 10¹¹ Ω, then we could conclude that the maximum distance d between the nanoparticles should be less than 1 nm and uncertainty in the position of nanoparticles in the lattice smaller than 0.5 nm.

The resistance of the nanoparticle array depends not only on d and σ but also on the material from which the nanoparticles are made of, or more precisely on the working function of that material. The dependence of R on the distance between the nanoparticles and on the working function of the material is shown on FIG. 7. It is seen from the figure that R increases quickly with the W_{f}. It also follows from the figure that the distance d between the nanoparticles could be increased as W_{f} decreases in order for R not to exceed the upper limit. For example, at a distance d=2 nm and W_{f}=1 ev the resistance R is 10¹¹ Ω.

An alternative way for reducing the working function is to use a thin layer of organic material attached to metal nanoparticles as taught by V. De Renzi et al. in Phys. Rev. Lett. 95, 046804 (2005) “Metal Work-Function Changes Induced by Organic Adsorbates: A Combined Experimental and Theoretical Study”, which is incorporate herein by reference. This work shows that the gold work-function changes by about −1.6 eV by using organic adsorbents (CH₃S)₂. It is further preferred to use bisthiolated alkane to connect adjacent metallic nanoparticles. A bisthiolated alkane linker in addition to reducing the working function would act as a flexible linker that will also keep the nanoparticles attached and will allow them to return to their place after each deformation.

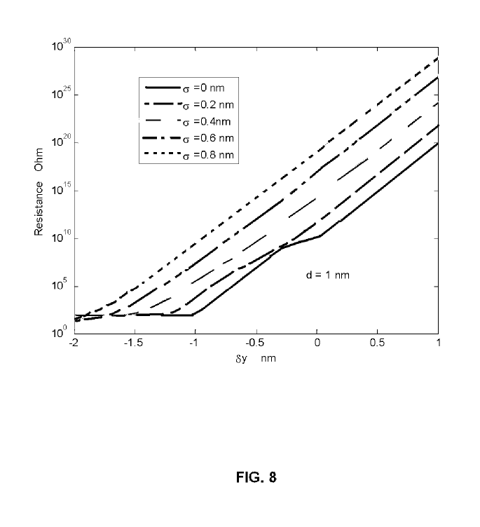

FIG. 8 is a theoretical (calculated) plot of resistance versus nanoparticle displacement δy_{b} assuming an initial mean distance between the nanoparticles d was 1 nm. Negative values of δy correspond to the compression while positive values of δy correspond to the expansion of the structure. We can see from the figure that R exponentially increases with δy nearly in all ranges of displacement except large negative displacements (smaller −1 nm) when it approaches a constant value. The dependence of R on δy is really dramatic. Changing δy by about 1 nm changes R in about 10¹⁰ times!

Accordingly, a small increase in particle spacing, leads to a more than exponential increase in resistance, Hence, by selection of the device dimension through the selection of polymer layer(s) 220 and deposition and attachment of the particle 230 a device can be constructed wherein the slightest perturbation to the dense array of particles will initiate a large change in resistance. Further, since the particle array 235 is spatially uniform it can be decreased in size to the minimum number of particle necessary to make ohmic contact with external junctions.

However, a dispersed particle array cannot be subdivided to such an extent because as the scale of division approaches the percolation scale there will be massive variations in the particle density and spacing, hence giving wide fluctuations in the base resistance and the dynamic range of each such portion. For the same reasons local deformations of such prior art materials smaller that the percolation scale cannot be reliability measured.

In contrast, the sensor device of the instant invention can be reduced on a lateral scale commensurate with the event or object to be measured, as same local deformation of the substrate will produce the same response regardless of the lateral position in the array. Finally, as the nano-sensor has molecular dimensions it can be expected to be responsive to and detect molecular motion on a comparable scale, which is just above phonon vibrations. Further, the homogenous nature of the conductive particle array ensures ohmic contact with external electrodes, which can be problematic when conductive particles are dispersed in an insulating matrix, as the matrix can form an outer layer of the device.

The substrate 210 is optionally rigid or non-rigid relative to the polymer layer 220. It should also be understood that the description of the substrate as non-rigid is only to the extent that the combination of modulus of elasticity and thickness do not inhibit the response of the polymer layer 220 that results in a disturbance to the array of particles 235. Accordingly, depending on the substrate thickness alternative substrates include, without limitation, inorganic materials such as mica (nominally K2O.Al2O3.SiO2), silicon, silicon dioxide, glass and organic materials, or alternative organic polymers such as polydimethylsiloxane (PDMS), Polymethylmethacrylate (PMMA), polymers of Hydroxy ethyl methacrylate (HEMA) monomer, cellulose, azlactone polymers, polystyrene, and the like. Depending on the relative elasticity and thickness of each of the substrate 210 and the polymeric spacer 220, either can initiate the disturbance in the particle array 235 that actuates the sensor 200.

It should also be appreciated the term “substrate” may also encompass the underlying article or device to be measured. In such instances, an initial substrate used in fabrication might be sacrificial or removed in the process.

Another aspect of the invention is a method for creating array of particles that forms the sensor element described with respect to FIG. 1. From the foregoing discussion of the widely known methods and availability of nanoparticles of different sizes and compositions, it should be apparent that the nanoparticles can be attached directly to the polymeric layer 220, which acts as a spacer from substrate 210. However, a preferred process for producing an ordered and dense array 235 of nanoparticles with controlled and predicable properties is illustrated in FIG. 2. This process comprises the steps of first depositing one or more polymeric layers 220 on a substrate 210, attaching initially a smaller particle 229 to the outer surface 220a of the outermost deposited polymer layer 220, and then enlarging the size of the particles until they reach the desired size, shown in dashed lines as enlarged particle 230. Generally, the initial spacing 239 between these particles 229 is dependent on the density and location of functional groups on the outer surface 220a of polymer spacer 220. Ideally, the spacing should be uniform. This can be controlled by the density and uniformity of functional reactive groups on the polymer, or by pre-treating the surface with a specific coupling that limits its own surface coverage through steric interactions that preclude a higher density of attachment. The desired size of the final particle 230 is that which sufficiently reduces the gap 240 to provide the intended sensitivity and dynamic range, which will depend on the method in which the disturbance of the particle array 235 is measured. In either case, the initially deposited particles 229 are grown until the spacing 240 is reduced such that deformation or disturbance to the polymer layer 210 with be reflected in the movement of the larger particles 230 such that a measurable perturbation occurs in the particle array 235.

In a preferred embodiment, the initially deposited nanoparticles of gold have a diameter of about 1.4 nm, after which the diameter is preferable grown to about 20 to 100 nm, depending on the initial particle 229 spacing. Such methods of nanoparticle enlargement are well known in the field of histology, wherein various reagents are commercially available to cover nanospheres of gold with silver, gold or silver followed by a thin gold coating. For example the “GoldEnhance”™ reagent kit is also available from Nanoprobes for this purpose. Alternatively, nanoparticles of gold can be expanded by incubation at room temperature in an aqueous solution of 0.5 mM HAuCl₄ and 0.5 mM NH₂OH for about 2 minutes. The substrate is then washed with water and blown dry with Nitrogen or another inert gas to complete the process. The gold particles are grown to the desired size by simply extending the incubation period in the Gold Enhance reagent for as long as is desired. Although it is possible to use repeated electrical continuity measurements to determine when the conductive particles have grown to the point at which they touch, a preferred method utilizes the change in color from blue, for the original NANOGOLD™ particles, to red as the particles grow to a size where they touch, and no longer interest with incident light as quantum dots. The change in color occurs because the surface plasmon resonance absorption of discrete gold nanoparticles red shifts with a broader spectral shape from the initial spectral placement (centered at roughly 545 nanometers) as the particles move farther apart. Accordingly, in the more preferred embodiments it is preferable that the substrate 210, or the combination of substrate and polymer spacer, are somewhat reflective so this red shift can be observed visually or measured in reflection from the substrate to terminate the growth of the nanoparticles of gold.

The thickness of the polymer spacer is generally at least twice the diameter of the nanoparticles, or about 40 to 200 nm. Attachment of the nanoparticle to outer surface 220a of the polymer layer can be by covalent or ionic bonds. Examples of useful polymers for spacer 220 are both homopolymer and co-polymer, such as PDMS, PMMA, HEMA, cellulose, Azlactone polymers, polystyrene, polystyrene sulfonate, polydimethyl-diallyl-ammonium chloride (PDMDA), polyethylene imine, polyacrylic acid and polylysine. Polymers with azlactone functional groups are particularly desired because an azlactone group at the surface will readily react with available primary amines to produce a highly stable covalent bond. Such polymers include poly (2-vinyl-4,4-dimethylazlactone-co-acrylamide-co-ethylene dimethacrylate). Another preferred polymer spacer of layer 220 is polylysine as negatively charged nanoparticles can be bound to the surface 220a through electrostatic interactions with the pendent amine groups. The polylysine can be linear, branched, hyper branched, cross-linked or dendritic, so long as it can be readily deposited as a thin, smooth layer on an underlying substrate. A convenient form of polylysine is a 0.5% aqueous solution available from Sigma Chemical Company.

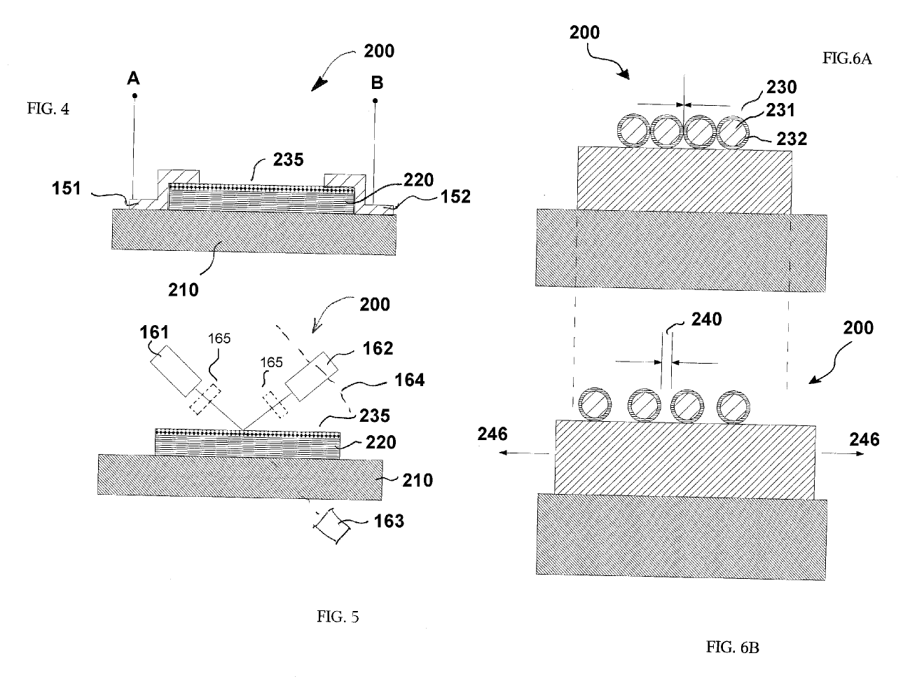

In another embodiment of the invention illustrated in FIG. 3, the polymeric layer comprises multiple layers of different polymeric materials. A particularly preferred embodiment is illustrated in FIG. 3 in which multiple, that is at least two polymer layers are deposited on the substrate. Thus, as shown in the Figure, polymer spacer 220 now comprises three polymer layers. The first layer 221 is deposited on substrate 210, then layer 222 is deposited on layer 221, and finally layer 223 is deposited on layer 222. Particles 230 form an array 235 on the outer surface 223a of layer 223.

The use of multiple layers of polymers to form the polymer spacer layer 220 shown in FIG. 3 has several advantages. Using multiple layers of a polymer to coat a substrate results in greater planarization of the resultant coating. Using multiple layers of different polymeric materials provides the opportunity to separately optimize the physical/chemical properties of the polymer that causes a disturbance in the particle array 235 in response to a stimulus from chemical structure and properties of the outer layer 220a that provides the desired type and density of binding sites to control the density of particles in the array to optimize the device sensitivity bonding. That is one polymer layer may provide either desired level of elasticity for mechanical sensing, or particular reactive groups for chemical sensing, while the outer layer may provide other functional groups, or a particular control or density of functional groups for bonding the desired particle or nanoparticles in an ordered array on the surface of the outer polymer layer.

The polymer spacer 220 may comprise multiple alternating sub layers of positively and negatively charged ionic polymers. The polymer spacer 220 may comprise multiple alternating sub layers of polylysine and polyacrylic acid, with polylysine as the terminal layer. In this embodiment, the nano-particles are functionalized to ultimately react with surface amino groups on polylysine.

In particularly preferred embodiments a polymer layer deployed in polymer spacer 220 has one or more with functional groups providing chemical or physical reactivity wherein the interaction of the environment with the functional group on the polymer will produce a change or distortion in the thin polymer layer that ultimately disturbs the array of bound or attracted particles. Functional polymers include those having inorganic and organic functional polymers, including ionic groups, and are both solid and liquid (when not bound to a substrate). Such reactive polymers are well known for their action as reagents, catalysts, carriers of protecting groups, templates, ion-exchangers, selective sorbents, chelating agents, supports for enzymes and cells, and the like. The functional polymers may be linear, branched, hyper branched, dendritic or reactive crosslinkable prepolymers, degradable polymers, polymer resists, conducting polymers, and film-forming polymers. Thus, for example, depending on the specific functional group the sensor device 200 of FIG. 1 or 2 allows high resolution measurement of such properties as the detection of specific chemical species, the measurement of osmotic pressure, temperature, light, electric charge or current, and the like.

Any of the polymer layers 220 or polymer sub layers 221-223 shown in FIG. 1-3 may be formed or deposited by a variety of known methods, such as casting, dipping or spin coating from solution, depositing an oligomer or monomer on the surface of the substrate and then polymerizing the oligomer or monomer, electrochemical deposition, vapor or chemical vapor deposition.

A more preferred method of fabrication is illustrated by the following hypothetical example in which the structure is formed in reverse of the previous embodiments by first depositing the metallic nanoparticles on a flat surface (preferably coated by a positive photoresist to function as a sacrificial layer) and then depositing additional layers, after deposition, the array is connected to a non-rigid substrate, and released from the flat substrate. In summary of the details that follow the fabrication is done in the following way: Any flat substrate surface (e.g. a flat carbon-coated copper grid, Ruby mica, Silicone-S(111), etc) is coated by a photoresist. Metallic nanoparticles (e.g Au) are organized on the surface as an ordered super lattice, or nanoparticle array, in the presence of an organic linker (e.g. Alkanethiols, Benzene thio, etc) the nanoparticles are enlarged by a heating treatment. The modified surface is additionally modified with a thiolated charged molecule (for example: 3-Mercaptobenzoic acid or 4-Aminothiophenol). The charged modified surface is further modified by the layer-by-layer deposition method alternatively with charged polymers (e.g. Polycyclic acid and Poly-L-lysine) for several layers. A flexible substrate, e.g. Polyester, is activated to be charged, the substrate is attached to the upper layer (that should be oppositely charged towards the flexible substrate). The assembly is released from the first substrate preferably by developing the positive photoresist.

An exemplary prospective example of such a process is now provided in which first prime wafers with Si(111) surface on top of an Si(100) device, are preferably dice cut into 2 by 2 cm pieces, cleaned with isopropanol, piranha {(2:1)H₂O₂:H₂SO₄} solution for 20 min, washed with DI water, isopropanol, acetone rubbed and blown with dry N₂ and put to oven at 160° C. over night. This should result in an oxide layer of about 20 Å thickness, achieving a roughness of ˜2 Å. As non-limiting examples, the following photoresists can be applied: S 1805, S 1818 (S series photoresists, or their equivalents are available from Rohm and Haas Electronic Materials, Marlborough, Mass.), AZ 4562 (AZ series photoresists are available from Clariant Corporation, Electronic Materials business unit, Somerville, N.J.) and AZ 5214. Generally about 0.5 ml each of the photoresists listed above is applied on top of the prepared substrate and spin coated (4000 r.p.m, 45″), and heated on a hotplate at 110° C. to remove solvent and/complete curing, depending on the specific photoresist chemistry.

Following the teaching of Teranishi, t. et al. in the publication “Fabrication of Gold Nanoparticle Superlattices and Their Optical and Electronic Properties”, which is incorporated herein as Appendix 1, arrays of 2D gold nanoparticles may be prepared and deposited on the photoresist layer.

This is then followed by Layer-by-Layer deposition of polymers. The first polymer layer deposited is preferably deposited onto ionically charged nanoparticles. The ionic charging can be accomplished by, for example treatment with 4-Aminothiophenol, from aqueous 0.05 Tris buffer solution, pH=7.0, containing 3 mg mL⁻¹ of Poly(acrylic acid) (PAA), for >5 min; then the electrode is preferably thoroughly washed with water. The next polymer layer is then preferably deposited onto PAA layer from aqueous 0.05 Tris buffer solution, pH=7.0, containing 3 mg mL⁻¹ of Poy-L-lysine (PLL), for >5 min. The electrode is preferably thoroughly washed with from aqueous 0.05 Tris buffer solution, pH=7.0. The deposition of the two oppositely charged polymers is preferably repeated, to produce the desired number of polymer layers, forming an assembly. Next the assembly is adsorbed upon a flexible substrate.

A flexible substrate can be received by treating a flexible Polyimide surface with the procedure disclosed by Ikeda, S et al. “Direct photochemical formation of Cu patterns on surface modified polyimide resin” J. Mater. Chem., 2001, 11, 2919-2921, which is incorporated herein by reference. KOH treatment on polyimide film should form carboxyl acid groups of the a polyimide film (e.g. or Kapton® PST Toray-DuPont) by alkali treatment (5 mol dm⁻³ KOH aq., 50 uC, 5 min). The photoresist is then removed. The photoresist coating can be removed by using a wet process with Baker ALEG-355 (NMP, sulfone, amine, catechol) heated to 70° C.

In the next step, electrodes are then deposited on the nanoparticle array. Preferably, the direct deposition of gold electrodes on two opposing vertices, without the need for a resist layer can be accomplished by using a focused ion beam induced deposition (FIBID) in which the precursor molecule in its volatile state (e.g: dimethyl-gold-acetylacetonate) is introduced into a vacuum environment in the vicinity of the substrate for deposition. In this process, primary electrons and secondary ones emitted by the substrate dissociate the precursor molecule and the metal is deposited on the surface. With the FEINova 600 Dual Beam system the deposition is generally performed using a beam of about 20 KV and beam current of about 620 pA and a probe size of ˜10 nm achieving a deposition rate of 30 nm/min.

In another embodiment of the invention, FIG. 4 illustrates a full sensor device 200 that now includes electrodes 151 and 152 contacting opposing sides of the nanoparticle array 235 and extending to cover adjacent portions of the same side of substrate 210. Thus, the electrical resistance is measured between terminals A and B is used to determine if substrate 210 has been perturbed in a manner that effects the electrical continuity through array 235. It should be appreciated that the coating on substrate 210 may include any of the species described with respect to FIG. 1 through 3.

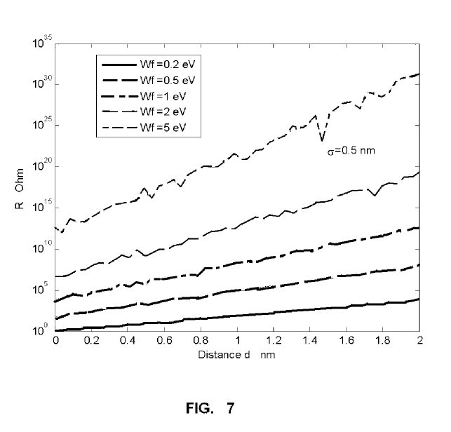

In another embodiment of the invention, FIG. 5 illustrates a sensor 200 that now includes a photodetector 162. The photodetector 162 preferably is a multichannel type capable of simultaneous measuring multiple wavelengths to detect spectral shifts in the emissive, absorptive or reflective properties of array 235 arising from a perturbation initiated by impact or deformation of the substrate 210 or polymer spacer layer 220. The device 200 optionally includes a photoemitter 161 when ambient light is not being either present or inadequate to generate a signal capable of measurement by photodetector 162. Alternatively, as perturbation in the structure of array 235 may also give rise to a unique diffraction pattern, photoemitter 161 optionally produces a collimated beam of incident radiation and photodetector 162 is capable of movement in arc 164 to measure the angular dispersion of scattered or diffracted radiation by array 235. Alternatively, a different photodetector 163 may be placed on the reverses side of substrate 110 from photoemitter 161 to measure the change in absorption spectra of array 235.

To the extent that the perturbation in array 235 is measured optically, that is by the change in transmission, reflection or absorption spectral or diffraction patterns, the nanoparticles are not necessarily conductive. Alternative nanoparticles for this purpose may include particle and nanoparticles that comprise wide band gap semiconductors, such as CdS, CdSe, PbS, ZnS, CdTe, ZnSe or other molecular-sized semiconductor crystals/nanocrystals that are highly fluorescent at a characteristic wavelength that would undergo a change or shift with the inter particle spacing. For example, particles includes nanocrystals and quantum dots are that absorb light then re-emit the light in a different wavelength, depending on the state of aggregation or contact, the method of optical detection may include florescence measurement. It is well known that the size of the nanocrystal determines the color. For example, the peak fluorescence wavelength of highly crystalline CdSe of 25 nm particle size is tunable with a 2-10 nm change in diameter.

It should also be appreciated that when optical measurements alone are deployed to characterize or detect the perturbation in particle array 235, the polymer layer 220 that spaces the particle 230 from substrate 210 need not be non-conductive. However, when optical measurements are used to interrogate the particle spacing in the array non-conductive particles can be used.

The device in FIG. 5 may also include optical filters 165 to absorb or block characteristic wavelengths, as for example fluorescence wavelengths, such that photodetector 162 need not perform wavelength discrimination. Alternatively, optical filter 165 may be an agile variable filter or wavelength scanning device to provide wavelength discrimination to photodetector 162.

In alternative embodiments, the optical filtering component need not be a discrete component, but can be coated or chemisorbed on the particles. This is schematically shown in FIG. 6A, wherein particles 230 have a core 231 coated with an absorbing layer 232. Although the particles 230 do not initially touch to completely block light, layer 232 fills the molecular scale gap between them. Thus, depending on the absorption characteristics of coating 232, specific wavelengths of light would be blocked from transmission between opposite sides of substrate 210. However, as the particles 230 move apart in FIG. 6B in response to deformation of substrate 210 (as shown by arrows 246) a gap 240 opens between the outer layers of coating allowing light to pass through. One such example of an absorbing coating layer 232 is carbon monoxide to block infrared (IR) light.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

1. A sensor comprising:
a) a substrate,
b) a polymeric spacer layer disposed on said substrate,
c) an array of particles bonded to the surface of said polymeric spacer,
d) whereby deformation of at least one of said substrate and said polymeric spacer layer results in a perturbation to the distribution of the nano-particles in said array to produce a measurable change in the aggregate physical property of said array.

2. A sensor according to claim 1 wherein the physical property is at least one of electrical resistance, optical transmission, wavelength selective absorption of light and a diffraction pattern.

3. A sensor according to claim 1 wherein the particle are nanoparticles.

4. A sensor according to claim 3 wherein the nanoparticle are conductive and the polymer spacer is non-conductive

5. A sensor according to claim 3 wherein the nanoparticles are selected from the group consisting of Au, Ag, Pt, Pd, Ni(B) or Ni(Ph), ITO, SnO2 and the polymer spacer is non-conductive.

6. A sensor according to claim 2 wherein the particle are gold nanoparticles

7. A sensor according to claim 3 wherein the polymer spacer has a thickness that is at least about two times the diameter of the nanoparticles.

8. A sensor according to claim 4 wherein the polymer spacer has a thickness that is at least about two times the diameter of the nanoparticles.

9. A sensor according to claim 4 wherein the gap between the nanoparticles in the array is between about 0 to 2 nm

10. A sensor according to claim 9 wherein the gap between the nanoparticles in the array is between about 0.2 to 0.7 nm.

11. A sensor according to claim 1 wherein the polymer spacer comprises two or more layer of different polymers.

12. A sensor according to claim 1 wherein at least one of the polymer layers is a charged polymer.

13. A sensor according to claim 1 where the measured phenomenon is thermal expansion or contraction of the substrate.

14. A sensor according to claim 15 where the substrate is made out of two different materials with different thermal expansion coefficients.

15. A process for forming a sensor, the process comprising the steps of:
a) providing a substrate,
b) depositing at least one polymeric layer on the substrate,
c) depositing a sufficient quantity of particles on said polymer layer to form an array.
d) bonding the particles in the array to said polymer layer.

16. A process for forming a sensor according to claim 16 wherein the particles are spherical nanopartilce and further comprising the step of growing the nanoparticle size after said step of bonding to the polymer layer.

17. A process for forming a sensor according to claim 16 wherein said step of depositing at least one polymeric layer comprises polymerizing at least one of an oligomer and a monomer on the surface of said substrate.

18. A process for forming a sensor, the process comprising the steps of:
a) providing a first flat substrate,
b) depositing a nanoparticle array on the first flat substrate,
c) depositing at least one polymer layer onto the nanoparticle array
d) transferring the at least one polymer layer and bound nanoparticle array to a second substrate, and
e) releasing the nanoparticle array from the first flat substrate.

19. A process according to claim 18 further comprising,
a) depositing a positive photoresist on the first flat substrate before said step of depositing the nanoparticle array.

20. A process according to claim 19 further comprising the steps of:
a) ionically charging the nanoparticles in the array before depositing the first polymer layer, wherein the first polymer layer deposited is a charged polymer.
